(19) United States
(12) Patent Application Publication
(10) Pub. No.: US 2002/0141325 A1
(43) Pub. Date: Oct. 3, 2002

(54) Recording and reading method of optical disk

(76) Inventor: Katsuhiko Shinohara, Kakogawa-shi (JP)

Correspondence Address: Katsuhiko Shinohara, 669-20, Kimura, Kakogawa-choo, Kakogawa-shi, Hyogo, JP

(21) Appl. No.: 09/771,377

(22) Filed: Jan. 29, 2001

(30) Foreign Application Priority Data
Sep. 30, 2000 (JP) 2000-350304

(51) Int. Cl. G11B 7/00

(52) U.S. Cl. 369/120; 369/118

(57) ABSTRACT

The focus light spot of the returned light is divided in halves so as the returned light from the points on the line perpendicular to the recording track at the center of the reading focus light spot is divided in halves;

The recorded mark is discriminated by the difference in quantity of light at two parts in said focus light spot.

### BACKGROUND OF THE INVENTION

The present invention relates to a recording and reading method of an optical disk. By virtue of the improvement of an optical disk that uses magnetically-induced super resolution, the interval between recorded images has been about half the reading focus light spot diameter.

By virtue of the improvement of the shape of the reading focus light spot on an optical disk that is attained by shading the center part of a laser beam irradiated to objective, the improvement of resolution power in all kinds of optical disks has been implemented.

Therefore, it has been desired to accomplish the improvement in the photo-detecting method of the returned light from an optical disk.

The combination of the three above-mentioned techniques enables higher resolution power than each resolution power to be obtained separately.

### SUMMARY OF THE INVENTION

The object of the present invention is to provide a recording and reading method of an optical disk so as to resolve from one fourth to one fifth of the reading focus light spot diameter.

In this invention set addresses for recording are provided with the regular interval which is from one fourth to one fifth of the reading focus light spot diameter.

The returned beam of light from the optical disk is focused on the hole, which is divided into two with the phase plate that gives half a light wavelength delay.

Recorded marks in set addresses for recording are discriminated by the combination of the quantity of light detected by a photo detector and the change in it.

The present invention provides a recording and reading method of an optical disk that can be utilized for all kinds of optical disks in the market.

### BRIEF DESCRIPTION OF THE DRAWINGS

FIG. 1 shows the block diagram of an embodiment.

FIG. 2 shows the block diagram of the optical interference device in another embodiment.

FIG. 3 shows the photo-detecting surfaces of the photo detectors in two groups.

FIG. 4 shows the positional relationship between the set addresses for recording and the recorded marks on the optical disk.

FIG. 5 shows the light intensity distribution diagram of the recorded marks on the photo-detecting surface.

FIG. 6 shows the distribution graph of the detected quantity of light in relation to the position of one recorded mark in the reading focus light spot.

FIG. 7 shows the light phase and intensity distribution diagram on the photo-detecting surfaces of the photo detectors.

FIG. 8 shows the light phase and intensity distribution diagram on the photo-detecting surfaces of the photo detectors.

FIG. 9 shows the light phase and intensity distribution diagram on the photo-detecting surfaces of the photo detectors.

FIG. 10 shows the influence value graph in relation to the position of one recorded mark in the reading focus light spot over the detected quantity of light.

FIG. 11 shows the positional relationship between the set addresses for recording in the reading focus light spot.

FIG. 12 shows the positional relationship between the set addresses for recording in the reading focus light spot.

FIG. 13 shows the positional relationship between the set addresses for recording in the reading focus light spot.

FIG. 14 shows the positional relationship between the set addresses for recording in the reading focus light spot.

FIG. 15 shows the influence value graph in relation to the position of one recorded mark over the detected quantity of light when the slit is set just in front of the photo detector.

FIG. 16 shows the positional relationship between the set addresses in the reading focus light spot.

### DESCRIPTION OF THE PREFERRED EMBODIMENTS

An embodiment of the present invention is explained thereinafter referring to Figures.

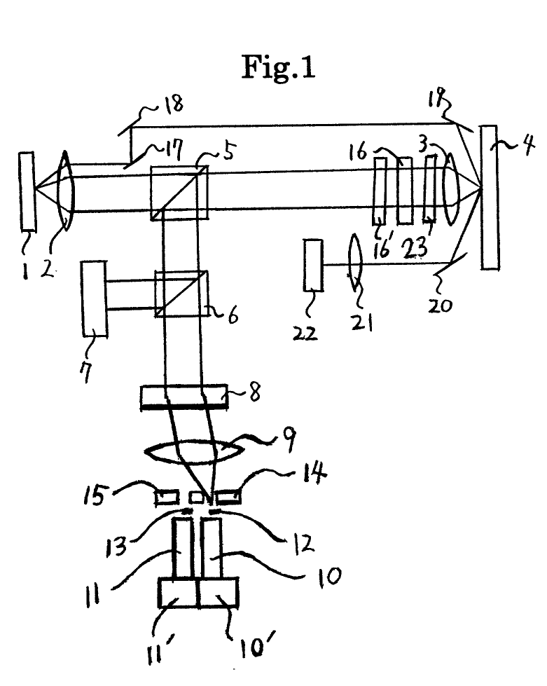

In FIG. 1, the laser beam emitted by a semiconductor laser source 1 is made parallel light by a coupling lens 2, and is focused on an optical disk 4 by an objective 3. The returned beam of light from the optical disk 4 is taken out by a beam splitter 5, positioned between the coupling lens 2 and the objective 3 on the optical path, and then is split into the beam of light in two directions by a beam splitter 6.

One beam of light is led to a photo detecting device for tracking and focusing 7.

The other beam of light is scanned with a light deflector 8 utilized electro-optical effect, and is focused on the edges of two optical fibers 10 and 11 by a convex lens 9.

The both edges of two optical fibers 10 and 11 are half covered with the phase plates 12 and 13 that give half a light wavelength delay, respectively.

The slits 14 and 15 are set just in front of the two optical fibers 10 and 11, respectively and are able to remove the returned beam of light from outside of the reading focus light spot on the optical disk 4.

During this reading operation, a light deflector 16, which utilizes electro-optical effect and is positioned between the beam splitter 5 and the objective 3 on the optical path, makes the reading focus light spot scan with high frequency and small amplitude in the direction of the reading track, and the light deflector 8 is synchronized with the light deflector 16.

A portion of parallel light generated by the semiconductor laser source 1 and passing through the coupling lens 2 is guided by plane mirrors 17, 18 and 19, and is irradiated obliquely on the optical disk 4 in the neighborhood of the reading focus light spot.

Reflected light from the optical disk 4 is led to a convex lens 21 by a plane mirror 20. A photo detector 22 at the focus point of the convex lens 21 detects the tilting amount of the optical disk 4 in the direction of the recording track in the neighborhood of the reading focus light spot by sensing displacement of the focus light spot through the convex lens 21.

Using this detected result, the light deflector 16′ utilized galvanomirror adjusts the center direction of high-frequency and small-amplitude scanning with the reading beam of light perpendicular to the direction of the recording track.

The light deflectors 8 and 16 are synchronized at extremely high frequency.

Semiconductor laser source 1 emits laser beam at constant light intensity.

The returned light from two neighbor positions in two reading focus light spots is detected separately with two photo detectors 10′ and 11′ connected to optical fibers 10 and 11, respectively.

When recorded information is recorded on the recording track on the optical disk 4, several recorded marks are formed in a straight line perpendicular to the recording track using a light deflector 23 for tracking which scans very frequently perpendicularly to the recording track and a light deflector 16′ for adjusting the positional errors caused by moving of the optical disk 4 in the direction of the recording track.

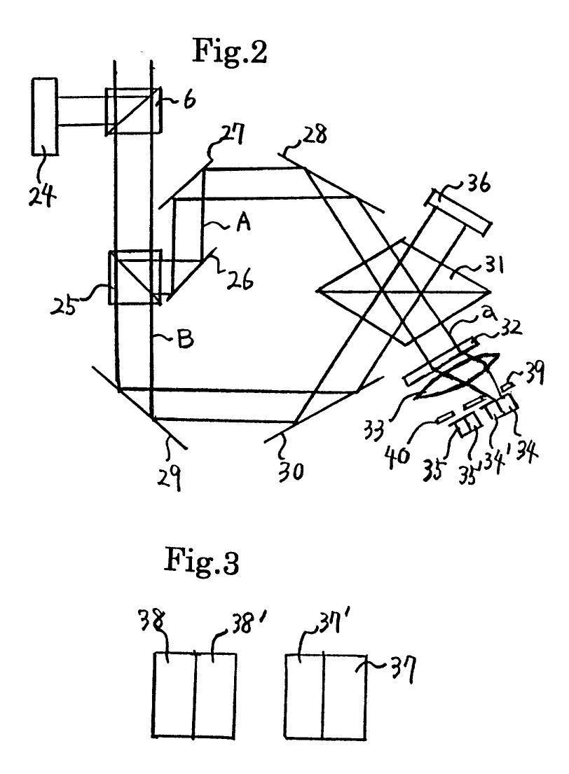

FIG. 2 shows another embodiment, one beam of light split in two directions by a beam splitter 6 is led to a photo detecting device for tracking 24. The other beam of light is split into two beams of light “A” and “B”, by a beam splitter 25. The optical path of the beam of light “A” is changed by plane mirrors 26, 27 and 28, and the optical path of the beam of light “B” is changed by plane mirrors 29 and 30.

Then the beam of light “A” and the beam of light “B” are adjusted to proceed in the same direction by a beam splitter 31, producing interfering beams of light “a” and “b”.

During this reading operation, a light deflector 32, which utilizes electro-optical effect, make the interfering beam of light “a” scan. And the interfering beam of light “a” is focused alternately on two neighboring groups of photo detectors 34 and 34′ and photo detectors 35 and 35′.

A photo detector for focusing detects the interfering beam of light “b”.

In FIG. 3 the light from a point on the line perpendicular to the recording track at the center of the reading focus light spot on the optical disk 4 is focused equally on two evenly divided portions existing on photo-detecting surfaces 37 and 37′ on photo detectors 34 and 34′ or photo-detecting surfaces 38 and 38′ on photo detectors 35 and 35′, respectively, by scanning. And the difference between the quantity of light detected by means of photo detector 34 and the quantity of light detected by means of photo detector 34′ and that between the quantity of light detected by photo detector 35 and the quantity of light detected by photo detector 35′ are calculated.

In this operation, the intensity of light on the detecting surfaces 37,37′, 38 and 38′ is at minimum and the phase of light is even all over the photo-detecting surfaces 37,37′, 38 and 38′ because the intensity of beam of light “A” is adjusted a little stronger than that of the beam of light “B”.

The unnecessary returned light from the optical disk 4 along the recording track is removed by the slit 39 just in front of the photo-detecting surfaces 37 and 37′ and the slit 40 just in front of the photo-detecting surfaces 38 and 38′. The light deflectors 16 and 32 scan at high frequency and small amplitude with schnchronization.

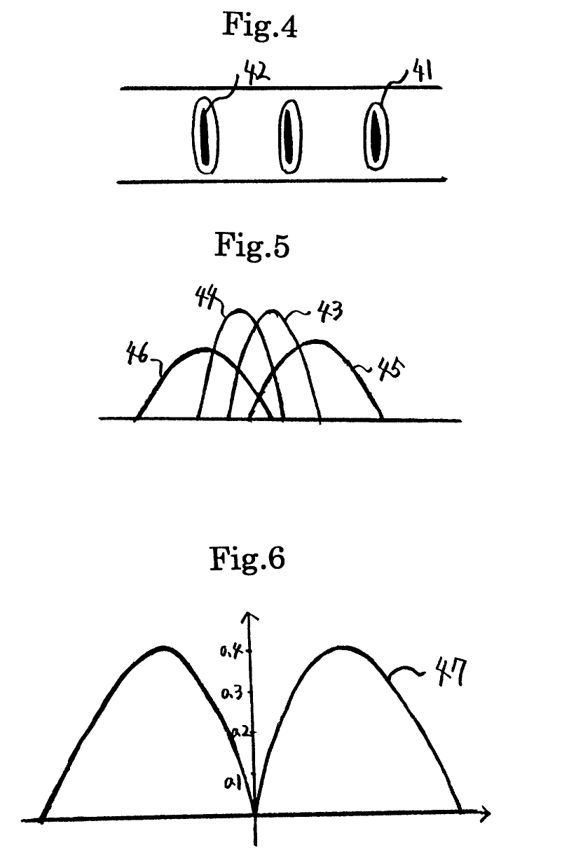

In FIG. 4, the linear recorded mark 42 recorded at the center of the set address for recording 41 is discriminated by the difference in fixed term in the detected quantity of light between photo detectors 10′ and 11′ or by the difference in fixed term between the difference in the detected quantity of light between photo detectors 34 and 34′ and that between photo detectors 35 and 35′ in combination with the change in the integrated those.

We are able to consider without contradiction that the returned light for reading the recorded mark 42 on the optical disk 4 consists of the returned light from the only recorded mark 42 and background light whose light phase has half a wavelength delay compared with the light phase of the returned light from the only recorded mark 42.

And then it is possible to consider that the background light influence on quantity of light detected by photo detectors 10′, 11′, 34 and 34 is almost zero.

In FIG. 5, the detected quantity of light returned from a point on the optical disk 4 (the detected quantity of light detected with the photo detector 10′ or 11′ or the difference in the detected quantity of light between the photo detectors 34 and 34′ or that between the photo detectors 35 and 35′) is able to calculate as half a non-common volume of two cones symbolized as the non-common area of the light intensity distribution diagrams 43 and 44.

When a light point on the recorded mark 42 separates from the center of the reading focus light spot, half a non-common volume of two cones is symbolized as the non-common area of the light intensity distribution diagrams 45 and 46.

Providing that the objective 3 and the convex lenses 9 and 33 have the same numerical aperture and the returned light from a point which moves on the line passing trough the center of the reading focus light spot along to the recording track is formed as the cones on the edges of the optical fibers 10 and 11 or the photo-detecting surfaces 37, 37′, 38 and 38′, whose radii and the heights are 1, respectively when the above-mentioned point exists in the center of the reading focus spot on the optical disk 4, the quantity of the above-mentioned returned light detected with the photo detectors 10′ and 11′ or the difference in the detected quantity of light between the photo detectors 34 and 34′ or that between the photo detectors 35 and 35′ are able to calculate through the equation as

⅓π(1−χ)−4(1−χ)∫₀^{1-χ}∫₀^{z}\sqrt{(χ+z)²−(χ+u)²}dχdu

and are shown by the graph 47 in FIG. 6.

Those numerical values are able to show as follows;

| | |
|---|---|
| χ = 0.050; 0.0992, | χ = 0.100; 0.1754, |
| χ = 0.150; 0.2464, | χ = 0.200; 0.3049, |
| χ = 0.250; 0.3507, | χ = 0.300; 0.3843, |
| χ = 0.350; 0.4061, | χ = 0.400; 0.4168, |
| χ = 0.415; 0.4179, | χ = 0.425; 0.4181, |
| χ = 0.435; 0.4180, | χ = 0.450; 0.4170, |
| χ = 0.475; 0.4135, | χ = 0.500; 0.4077, |
| χ = 0.550; 0.3897, | χ = 0.600; 0.3639, |
| χ = 0.650; 0.3315, | χ = 0.700; 0.2934, |
| χ = 0.750; 0.2506, | χ = 0.800; 0.2036, |
| χ = 0.850; 0.1551, | χ = 0.900; 0.1042, |
| χ = 0.950; 0.0523, | |

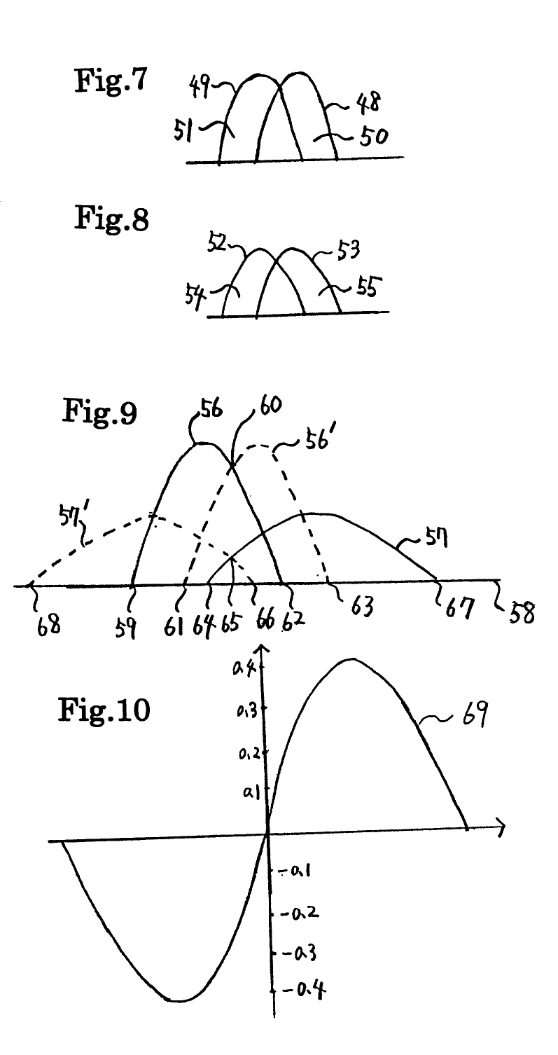

When a light point exists on one side in half the reading focus light spot divided by a line perpendicular to the recording track at the center of the reading focus light spot according to the embodiment of FIG. 2, the light phase on the photo detecting surfaces 37, 37′, 38 and 38′ is able to be shown as λ/2 for non-common area 50 and 0 for non-common area 51 whose one light phase has the difference of half a light wavelength compared with the other light phase in the light intensity distribution diagrams 48 and 49 in FIG. 7.

In FIG. 8, when a light point exists therefore on the other side in half an reading focus light spot, the light phase on the photo-detecting surfaces 37, 37′, 38 and 38′ is able to be shown as λ/2 for non-common area 54 and 0 for non-common area 55 whose one light phase also has the difference of half a light wavelength compared with the other light phase in the light intensity distribution diagrams 52 and 53.

In FIG. 9, when two light points exist on either side of the center line of the reading focus light spot on the optical desk 4 perpendicular to the recording track, the light phase and intensity distributions on the photo-detecting surfaces 37, 37′, 38 and 38′ are shown by their diagrams 56 and 57 and these symmetrically transformed distribution diagrams 56′ and 57′ show the returned light from two light points symmetrically transformed in relation to above-mentioned center line of the recording focus light spot about above-mentioned two light points, respectively.

Providing that the base line is shown by 58 and the intersectional points in the light intensity distribution diagrams and the intersectional points between the light intensity distribution diagrams and the base line are shown by 59, 60, 61, 62, 63, 64, 65, 66, 67 and 68, the light phase of the non-common area (59, 60, 61) is shown as λ/2 and the light phase of the non-common area (60, 62, 63) is shown as 0 in the two light intensity diagrams 56 and 56′, and the light phase of the non-common area (66, 65, 67) is shown as λ/2 and the light phase of the non-common area (64, 65, 68) is shown as 0 in the two light intensity diagrams 57 and 57′.

The intensity of background light is much greater than the intensity of light from the only recorded mark and the light intensity of the beam of light “A” is set a little bit stronger than that of light “B” through the light splitter 25, and the difference in the quantity of light on either side of the symmetrical line of the light phase and intensity distribution diagrams 56, 56′, 57 and 57′ is obtained through the equation as (K+H−J)˜(K−H+J)=2H˜2J, provided that each of the light quantity of the non-common area (59, 60, 61) and the light quantity of the non-common area (60, 62, 63) is H and each of the light quantity of the non-common area (66, 65, 67) and the light quantity of the non-common area (64, 65, 68) is J and the quantity of light from back ground light on either side of the symmetrical line of the light phase and intensity distribution diagrams 56, 56′, 57 and 57′ is K.

Therefore it is feasible to obtain the difference between the quantity of light detected by the photo detector 34 and that detected by the photo detector 34′ or between that detected by the photo detector 35 and that detected by the photo detector 35′ as the absolute value of the sum of each numerical values via graph 69 in FIG. 10 when the light returns from several points on either side of the center line of the reading focus light spot on the optical disk 4 perpendicular to the recording track.

The quantity of light detected by the photo detectors 10′ and 11′ in FIG. 1 is able to calculate via the same graph 69 in FIG. 10: it depends on which side or what distance from the center of the reading focus light spot the recorded marks 42 exist in.

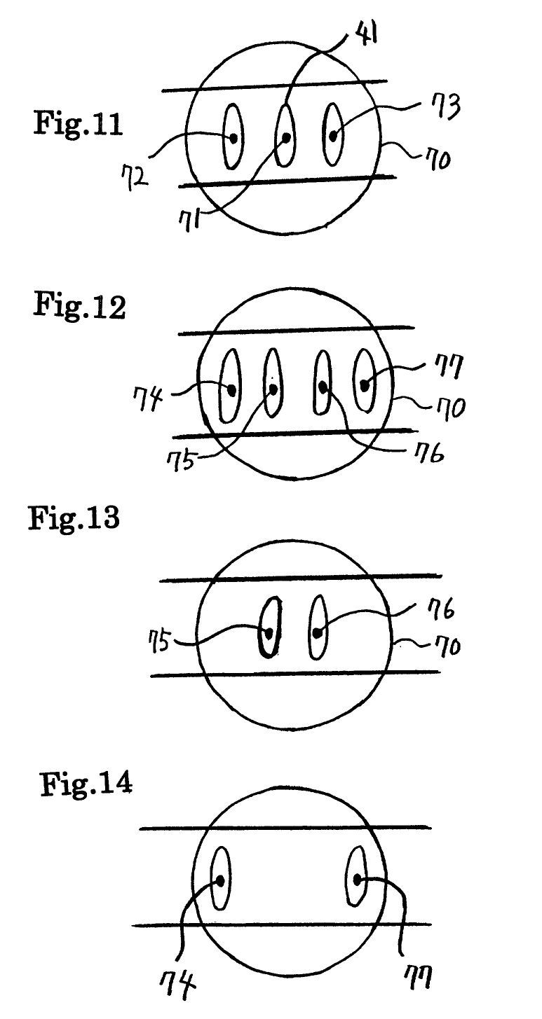

In the embodiment that the distance between the two adjacent set addresses for recording 41 on the optical disk 4 is half a radius, if there is the set address for recording 41 at the position 71 in the center of the reading focus light spot, there are two set addresses for recording 41 at the both positions 72 and 73 in FIG. 11.

F is gained through subtracting the quantity of light detected by the photo detector 10′ from that detected by the photo detector 11′ or subtracting the difference between the quantity of light detected by the photo detectors 34 and 34′ from that detected by photo detectors 35 and 35′ when the center of the reading focus light spot 70 is moved from the position 73 to the position 71.

And E is gained through integration of F or the quantity of light detected by the photo detector 10′ or 11′ or the difference in the detected quantity of light between the photo detectors 34 and 34′ or that between the photo detectors 35 and 35′.

If the only one recorded mark 42 exists in the set addresses for recording 41 at the position 72 or 73 within the reading focus light spot, E=E′.

In FIG. 10 and the before-mentioned numerical value table, if the recorded mark 42 does not exist in the set addresses for recording 41 at all the positions, E=0 and F=0.

If the recorded marks 42 do not exist in the set address for recording 41 at the position 71 and exist in the set addresses for recording 41 at all the positions 72 and 73, E=0 and F≈−0.027.

If the recorded mark 42 does not exist in the set address for recording 41 at the position 71 and exists in the set address for recording 41 at the only position 72, E≈0.41 and F≈−0.009.

If the recorded mark 42 does not exist in the set address for recording 41 at the position 71 and exists in the set address for recording 41 at the only one position 73, E≈0.41 and F≈−0.018.

If the recorded mark 42 exists in the set address for recording 41 at the position 71 and does not exist in the set addresses for recording 41 at the both positions 72 and 73, E=0 and F≈0.092.

In this case, if the recorded mark 42 is moved from the position 71 to the position 73 for a quarter of the reading focus light spot radius, E≈0.351 and F≈0.034.

On this occasion, if a new recorded mark 42 enters in the reading focus light spot 70, E≈0.100 and F≈0.009.

If the recorded marks 42 exist in the set addresses for recording 41 at all the positions 71, 72 and 73, E=0 and F≈0.065.

In this case, if the recorded marks are moved from the position 71 to the position 73 for a quarter of the reading focus light spot radius, E≈0.251 and F≈0.032.

On this occasion, if a new recorded mark 42 enters in the reading focus light spot 70, E=0 and F≈−0.010.

If the recorded marks 42 exist in the set addresses for recording 41 at the only positions 71 and 72, E≈0.408 and F≈0.083.

If the recorded marks 42 exist in the set addresses for recording 41 at the only positions 71 and 73, E≈0.408 and F≈0.074.

And if E and F are the above-mentioned values, the recorded marks exist in the set addresses for recording 41 at the only above-mentioned positions.

And if E=0, the recorded marks 42 exist only in the symmetrical set addresses for recording 41 in relation to the center of the reading focus light spot 70 or do not exist in all the set addresses for recording 41 in the reading focus light spot 70.

In FIG. 12, if the set addresses for recording 41 at the positions 74, 75, 76 and 77 are symmetrical in relation to the center of the reading focus light spot 70 and are all occupied with the recorded marks 42, E=0 and F≈−0.010.

In FIG. 13, the recorded marks 42 exist in the set addresses for recording 41 at the only positions 75 and 76, E=0 and F≈0.079.

In this case, if the recorded marks 42 are moved from the position 71 to the position 73 for a quarter of the reading focus light spot radius, E≈0.408 and F≈−0.074.

In FIG. 14, if the recorded marks 42 exist in the set addresses for recording 41 at the only position 74 and 77, E=0 and F≈−0.090.

In this case, if the recorded marks 42 are moved from the position 71 to the position 73 for a quarter of the reading focus light spot radius, E≈0.408 and F≈−0.009.

The judgment that the recorded mark 42 exists in the center of the reading focus light spot 70 is given by the combination of E>0.4 and F>0.07 or E=0 and F>0.05, and then by the exclusion of E>0.30 and F>0.06 or E>0.30 and F<0.01 when the recorded marks 42 are moved from the position 71 to the position 73 for a quarter of the reading focus light spot radius.

When only one recorded mark 42 exists within the reading focus light spot 70, in the embodiment that the interval between the position at which the quantity of light detected by the photo detectors 10′ and 11′ or the difference in the detected quantity of light between the photo detectors 34 and 34′ or that between the photo detectors 35 and 35′ is at the maximum and the center of the reading focus light spot 70 is the interval between the adjacent set addresses for recording 41, the interval between the adjacent set addresses for recording 41 is a little shorter than half the reading focus light spot radius via the diagram 47 in FIG. 6 or the before-mentioned numerical value table.

The farther one recorded mark 42 is left from the center of the reading focus light spot 70, the more a part of the returned light from the optical disk 4 is excluded by the slits 14, 15, 39 and 40.

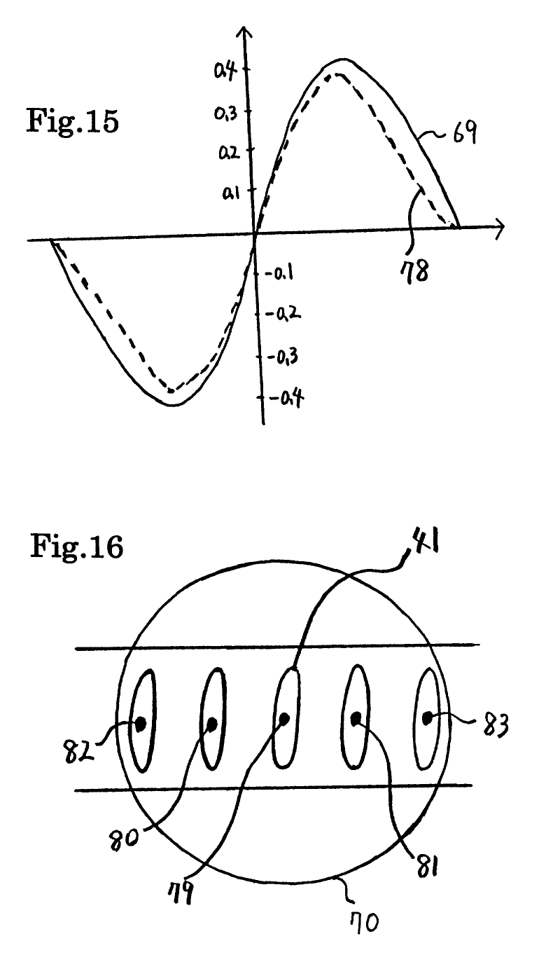

Consequently, the diagram 78 in FIG. 15 shown by the dotted line gives the influence values over the quantity of light detected by the photo detectors 10′ and 11′ or the difference between the quantity of light detected by the photo detectors 34 and 34′ or that detected by the photo detectors 35 and 35′ when one recorded mark 42 exists with several recorded marks 42 within the reading focus light spot 70.

In FIG. 16, when the set address for recording 41 exists therefore at the position 79 in the center of the reading focus light spot 70 and the only one recorded mark 42 exists at the position 80 or 81 or at the position 82 or 83 within the reading focus light spot 70, E=0.418−C1 and E=0.155−C2, respectively.

Therefore, there are five numerical values about E:E=0, E≈0.078, E≈0.222, E≈0.3 and E≈0.378.

According to the diagram 78 in FIG. 15, the recorded marks 42 that exist in the set addresses for recording 41 at the positions 80 and 81 have very little influence on the numerical values F.

As the first case, if the recorded mark 42 does not exist in the set address for recording 41 at the position 79 and exists in the set address for recording 41 at the only position 82 out of the positions 82 and 83, F≈−0.024.

If the recorded mark 42 does not exist in the set address for recording 41 at the position 79 and exist in the set address for recording 41 at the only position 83 out of the positions 82 and 83, F≈−0.025.

When the recorded marks 42 exist in the set addresses for recording 41 at all the positions 80, 81 and 82 or 80, 81 and 83 or at the only position 82 or 83, E≈0.078.

When the recorded mark 42 exist in the set addresses for recording 41 at the only positions 82 and 80 or 81 and 83, E≈0.378.

And when the recorded marks 42 exist in the set addresses for recording 41 at the only positions 82 and 81 or 80 and 83, E≈0.222.

As the second case, if the recorded marks 42 do not exist in the set address for recording 41 at the position 79 and exist in the set addresses for recording 41 at all the positions 82 and 83, F≈−0.050.

When the recorded marks 42 exist in the set addresses for recording 41 at the only one position 80 or 81, E≈0.3.

And when the recorded marks 42 exist in the set addresses for recording 41 at the both positions 80 and 81 or do not exist there, E=0.

As the third case, if the recorded marks 42 do not exist in the set addresses for recording 41 at all the positions 79, 82 and 83, F≈0.

When the recorded marks 42 exist in the set addresses for recording 41 at all the positions 80 and 81 or do not exist there, E=0.

And when the recorded mark 42 exists in the set addresses for recording 41 at the only one position 80 or 81, E≈0.3.

As the fourth case, if the recorded marks 42 exist in the set addresses for recording 41 at the both positions 79 and 82, F≈0.068.

If the recorded marks 42 exist in the set addresses for recording 41 at the both positions 79 and 83, F≈0.067.

When the recorded marks 42 exist in the set addresses for recording 41 at all the positions 79, 80 and 81, E≈0.078.

When the recorded marks 42 exist in the set addresses for recording 41 at all the positions 79, 81 and 82 or 79, 80 and 83, E≈0.222.

And when the recorded marks 42 exist in the set addresses for recording 41 at all the positions 79, 80 and 82 or 79, 81 and 83, E≈0.378.

In the fifth case, if the recorded marks 42 exist it the set addresses for recording 41 at all the positions 79, 82 and 83, F≈0.043.

When the recorded marks 42 exist in the set addresses for recording 41 at all the positions 79, 80, 81, 82 and 83 or 79, 82 and 83, E=0.

And when the recorded marks 42 exist in the set addresses for recording 41 at all the positions 79, 80, 82 and 83 or 79, 81, 82 and 83, E≈0.3.

In the sixth case, if the recorded marks 42 exist in the set address for recording 41 at the position 79 and do not exist in the set addresses for recording 41 at all the positions 82 and 83, F≈0.092.

When the recorded marks 42 exist in the set addresses for recording 41 at the only positions 79, 80 and 81 or 79, E=0.

And when the recorded marks 42 exist in the set addresses for recording 41 at the only positions 79 and 80 or 79 and 81, E≈0.3.

The above-mentioned combination of numerical values F and E in the first, second and third cases are the necessary and sufficient condition that the recorded mark 42 does not exits in the center of the reading focus light spot 70.

Therefore, the recorded mark 42 is discriminated by detecting the set addresses for recording 41 in the center of the reading focus light spot 70 in which the recorded mark 42 does not exist or by detecting the quantity of light (E) that is 0 at the regular intervals of half a distance between two adjacent set addresses for recording 41, if the recorded marks exist in all the set addresses for recording 41 in much wider range than the reading focus light spot 70 range, referring to the numerical values F and E in the above-mentioned fourth, fifth and sixth cases.

There is an embodiment to use only one optical fiber with one photo detector without the deflector 8 and 16 in FIG. 1. On this occasion, the numerical value E is gotten by the quantity of light detected with the photo detector 10′ or 11′ and the numerical value F is gotten by the difference between the quantity of light with the photo detector 10′ or 11′ from moving of the optical disk 4.

There is an embodiment to detect the light divided halves at the focus spot of the convex lens 9 without slits 14 and 15.

There is an embodiment to use convex lens that mixes light passing through the phase plates 12 and 13 instead of the optical fibers 10 and 11.

There is an embodiment to use a reading focus light spot irradiated in a pulse at very short regular intervals for high-frequency and small-amplitude scanning.

There is an embodiment to fill the optical path from the beam splitter 25 to the beam splitter 31 with transparent substance.

There is an embodiment to make the positions of the set addresses for recording 41 which exist both on lands and on grooves line up in a line perpendicular to the direction of the recording track.

There is an embodiment to use the difference in the detected quantity of light between the photo detectors 10′ and 11′ or the difference between the difference in the quantity of light between the photo detectors 34 and 34′ and the difference in the quantity of light between the photo detectors 35 and 35′.

According to the present invention of the recording and reading method of optical disk, the graph 47 in FIG. 6 shows the distribution of the detected quantity of light in relation to the position of one recorded mark 42 in the reading focus light spot 70, and when several recorded marks 42 exist within the reading focus light spot 70, the graph 69 in FIG. 10 shows the influence value in relation to the position of one recorded mark 42 over the detected quantity of light.

There are two nonsymmetrical mountains in the graph 47 in FIG. 6 and the graph 69 in FIG. 10, and the distance between the two tops of the mountains is less than a radius, while heretofore distribution graph of the detected quantity of light in relation to the position of one recorded mark 42 in the reading focus light spot 70 draws one symmetrical mountain.

Therefore the present invention of the recording and reading method of optical disk implements the resolution power within diffraction limit.

If the height of the light intensity distribution graph in the reading focus light spot 70 is g, the center portion of the reading focus light spot 70 in the present invention of the recording and reading method of optical disk has a slope of about 1.8 g according to the graph 47 in FIG. 6 and the graph 69 in FIG. 10 or the before-mentioned value table, while heretofore the recorded mark in the reading focus light spot is distinguished by the slope of g.

Therefore the present invention of the recording and reading method of optical disk has enough sensitivity to discriminate the recorded marks 42.

The influence from the recorded marks 42 over the detected quantity of light is decided by the sizes, figures and positions of the recorded marks 42 and the quantity of light irradiated to the recorded marks 42 regardless of the scanning speed of the reading focus light spot.

And when the scanning speed becomes extremely high, the influence in uneven movement of the disk 4 caused by waving thereof reduces and the angle between the reading beam of light and the direction of the recording track and the degree of out-of-focus become constant.

According to the present invention of the recording and reading method of optical disk, the polarization degree from the semiconductor laser source 1 or the reflection on the surfaces of the mirrors and lenses does not have an influence on the quantity of light detected by the photo detectors 10′, 11′, 34, 34′, 35 and 35′, and non-homogenous deflection portions on the optical disk 4 are discriminated and then we are able to avoid recording in the set addresses for recording 41 there.

According to the embodiment in FIG. 1, the quantity of light on either side of the focus spot just in front of the phase plate 12 or 13 through the convex lens 9 separated by the phase plate 12 or 13 that returns from respective lands and grooves on the optical disk 4 is respectively equal regardless of the change in the direction of the recording track on the optical disk 4.

Therefore, the influence in the change in it is zero because the distance from the phase plate 12 or 13 to the photo detector 10′ or 11′ is very longer than the diameter of the focus spot of the convex lens 9.

According to the present invention of the recording and reading method of optical disk, the difference in light intensity between divided two portions in the focus light spot through convex lens 9 is detected by optical interference method through phase plate 12 and 13.

Therefore it is possible to discriminate the recorded marks 42 with a higher signal-to-noise ratio.

According to the embodiment in FIG. 2, as the influence in the vibration and temperature is the same in very short period, the difference in the detected quantity of light by the photo detectors 34, 34′, 35 and 35′ almost satisfies the same requisites as to keep the interference conditions for the beam of light “a” constant.

According to the present invention of the recording and reading method of optical disk, the same optical disk head can be applied to all the existing optical disk.

The reading beam of light is irradiated perpendicularly to the recording track as a result of measuring the tilt of the recording track in the neighborhood of the reading light spot, so that it is possible to remove the unnecessary returned light from optical disk 4 in the direction of the recording track with the slits 14, 15, 39 and 40 and exactly divide the focus light spot of the returned light in hales: the less cross talk in the direction of the recording track is achieved and F and E are able to take the expectable values.

While a few embodiments of the invention have been illustrated and described in detail, it is particularly understood that the invention is not limited thereto or thereby.

What is claimed is:

1. A recording and reading method of an optical disk comprising;
focusing a returned light from said optical disk;
detecting quantity of light at two parts in a focus light spot divided in halves of said returned light from said optical disk;
detecting the returned light divided in halves from the points on a line that passes the center portion of the reading focus light spot on said optical disk and perpendicular or almost perpendicular to a recording track of said optical disk;
getting the difference in the quantity of light detected at said two parts in said focus light spot divided in halves of said returned light from said optical disk.

2. Said recording and reading method of claim 1, wherein a phase plate is located on one side of said two parts in said focus light spot divided in halves of said returned light from said optical disk to give half a light wavelength delay.

3. Said recording and reading method of claim 1, wherein a light deflector makes a reading beam of light scan with high frequency and small amplitude in a direction along said recording track of said optical disk.

4. Said recording and reading method of claim 1, wherein recorded marks are discriminated between them by subtracting values in regular order of the quantity of light detected by photo detectors 10 and 10′ when a reading beam of light scan with said high frequency and small amplitude in a direction along said recording track of said optical disk or by subtracting values in regular order of the quantity of light detected by photo detector 10 or 10′ when said optical disk moves a little distance without said reading beam of light scanning.

5. Said recording and reading method of claim 1, wherein said recorded marks are discriminated between them by integrating values of said subtracting values in regular order in said quantity of light detected by said photo detectors 10 and 10′ when said reading beam of light scans with said high frequency and small amplitude in a direction along said recording track of said optical disk or by said quantity of light detected by said photo detector 10 or 10′ when said optical disk moves a little distance without said reading beam of light scanning.

6. Said recording and reading method of claim 1, wherein said recorded marks are discriminate between them by the difference in said quantity of light detected by said photo detectors 10 and 10′ when said reading beam of light scans with said high frequency and small amplitudes in a direction along said recording track of said optical disk or by the difference in said quantity of light detected by said photo detector 10 or 10′ when said optical disk moves a little distance without said reading beam of light scanning.

7. Said recording and reading method of claim 1, wherein a distance between said recorded marks is that between a position at the center of said reading focus light spot and a position at which the maximum value of said detected quantity of light by said photo detector 10 or 10′ is given while one recorded mark moves within said reading focus light spot.

8. Said recording and reading method of claim 1, wherein said recorded mark is shaped into a perpendicular line to said recording track using both a light deflector for tracking and a light deflector for scanning in a direction of said recording track for correcting for the influence from said optical disk rotation.

9. Said recording and reading method of claim 1,wherein said returned light from said optical disk splits into two beams of light “A” and “B” whose optical paths are changed to be aligned, emerging as interfering beams of light “a” and “b”;
getting the same effect as making said returned light that is symmetrically transformed in relation to a line that passes the center portion of a reading focus light spot on said optical disk and perpendicular to said recording track of said optical disk and an original returned light interfere with each other;
having a slight light intensity difference between said beams of light “A” and “B” for making a same phase of light all over a focus light spot on photo detecting surfaces 37, 37′, 38 and 38′.
